(19) United States
(12) Patent Application Publication
(10) Pub. No.: US 2009/0238979 A1
(43) Pub. Date: Sep. 24, 2009

(54) Method of Applying Catalytic Solution for Use in Electroless Deposition

(76) Inventors: William Decesare, Wolcott, CT (US); James Watkowski, Middlebury, CT (US)

Correspondence Address: ARTHUR G. SCHAIER;CARMODY & TORRANCE LLP, 50 LEAVENWORTH STREET, P.O. BOX 1110, WATERBURY, CT, 06721, US

(21) Appl. No.: 12/052,859

(22) Filed: Mar. 21, 2008

(51) Int. Cl. B05D 3/10; B05D 3/04; B05C 11/00

(52) U.S. Cl. 427/305; 118/73

(57) ABSTRACT

An improved method of activating a surface to receive electroless metal plating thereon, particularly for use in activating through holes in printed circuit substrates, in which the activating solution comprising a palladium tin colloid in an acidic aqueous matrix is sparged with nitrogen gas to slow the oxidation of stannous tin contained therein. A dynamic flood conveyorized system to perform said activation is described.

### BACKGROUND OF THE INVENTION

1. Field of the Invention

The present invention relates to improving the method of conveyorized electroless deposition on a non-conductive substrate through the use of a catalyst on the substrate prior to electroless plating by retarding the oxidative effects of ambient oxygen on the catalytic solution, which are inherently made more detrimental in a conveyorized system. More particularly, the present invention relates to the use of nitrogen gas to displace ambient oxygen in the conveyor module to slow the oxidation of stannous ions and to lower the content of dissolve oxygen in the activator solution.

The method of the present invention is applicable in functional applications where metal deposited on a non-conductive surface renders the substrate thermally conductive, electrically conductive, stronger, or more rigid, or a combination of these properties. The method of the present invention may also be used in decorative applications, but is especially useful in the manufacture of printed circuit boards.

2. Description of the Prior Art

The method of electrolessly depositing metals on a non-conductive substrate using a tin-palladium colloidal catalyst, also known as a liquid activator solution, is widely known and utilized. The process involves contacting a non-conductive surface such as a plastic or cured resin first to a colloidal tin-palladium catalyst and preferably subsequently removing the tin in another solution to ensure that substantially a metallic palladium layer remains adsorbed onto the surface. These widely used tin-palladium catalyst solutions and the accelerators that remove the tin are described in U.S. Pat. No. 3,011,920 and U.S. Pat. No. 3,532,518, the disclosures of which are incorporated herein by reference in their entirety. Various metals are then able to be deposited onto the substrate in electroless plating baths that utilize reducing agents such as formaldehyde or hypophosphite. Any number of conventional copper or nickel (or other electroless metal plating solutions) can be used in this step. In the case of nickel deposition, a suitable plating solution is described in U.S. Pat. No. 2,532,283, Example III, Table II. Similarly, a suitable copper plating solution is disclosed in U.S. Pat. No. 3,095,309, Example 2. Since the electroless metal deposition is usually thin, this process is typically followed with conventional electroplating with copper, nickel, or any other desired metal.

Historically, this process, and especially the catalytic step, has been carried out in “vertical” dipping tanks. In such a process, the substrate is simply dipped into tanks containing each solution or colloid for a prescribed period of time. However, this process has proven to yield somewhat inconsistent coatings, which are highly detrimental, especially in the manufacture of printed circuit boards, where uniform coatings are required to obtain the proper reproducible electrical conduction. Printed circuit boards are required to contain drilled “through holes” through which electrical current must be able to pass. These through holes are simply holes that are drilled through the various layers of the circuit board, but because each layer is primarily comprised of a cured resin plastic, these holes are not conductive. Thus, the above described process is utilized to deposit a layer of copper in these holes to render them conductive. However, these holes are generally quite small, which makes solution-substrate contact a more difficult proposition. This difficulty is seen throughout the process, with every solution the substrate must come into contact with, including the catalytic colloid.

Various methods have been employed and patented to alleviate the difficulty of inconsistent coating while maintaining the vertical dipping process. These methods have ranged from the addition of a mechanism that moves the substrate in a periodic motion, to a mechanism that mixes and stirs the solutions and colloids, to the use of surfactants, to even an elaborate mechanism that quickly vibrates the substrate as disclosed in U.S. Pat. No. 5,077,099. However, none of these remedies provide as consistent a coating, or are more productive and efficient, as abandoning the vertical dipping method altogether to utilize a conveyorized process. Such processes are becoming more and more mainstream and expected by industry such that there is a demand for the entire process from pre-catalyst conditioning to electroless plating to be viable in a fully conveyorized dynamic.

Dynamic conveyors operate in two different ways. One utilizes a spray type mechanism wherein the substrate is conveyed through the module and sprayed with the activating solution or colloid, which is pumped up from a reservoir beneath the main conveyance chamber. After contact with the solution, the liquid drains back down into the reservoir chamber to be pumped up again. The second type of conveyance, and the type that this invention would preferably lend itself to, is a dynamic flood conveyor. Such a mechanism is described in U.S. Pat. No. 4,724,856. Fundamentally, the substrate is conveyed into the module through a selectively closed mechanism, usually two rollers held tightly together. Inside the module is maintained a flowing “river” of the activating solution which is pumped up from a reservoir on, and drained back down. Utilizing these means of contacting the solution with the substrate result in more consistent and uniform coatings. The motion of the liquid and the substrate itself allows even the narrow through holes to be continuously contacted by fresh solution. Additionally, the use of conveyorized systems leads to much increased productivity and efficiency.

However, there arise certain complications with using a conveyorized system, especially with tin-palladium catalysts, which the present invention aims to alleviate. The tin in the tin-palladium catalyst performs two critical functions. First, when making the colloid, the stannous tin ions reduce the Pd2+ ions from palladium chloride to metallic palladium particles, which will constitute the colloid, and are thereby oxidized to stannic ions, which then become functionless as complexed stannic chloride. Second, and most importantly for the present invention, after the reduction of all palladium ions, the remaining stannous ions are able to stabilize the metallic palladium in colloidal form. This results in a very stable colloid, but if these stannous ions were not present or become oxidized to stannic ions, the colloid would be rendered useless. Unfortunately, stannous ions are quite sensitive to oxidation, and are spontaneously oxidized by atmospheric oxygen at even standard temperature and pressure. In the vertical dipping system, the loss of stannous ion from ambient oxygen is mostly negligible because the solution is essentially motionless with respect to the air above it. Nevertheless, in a conveyorized system, the solution is in constant motion, as it is pumped, stirred, and sometimes sprayed.

The result of such disturbances and perturbations is that fresh oxygen is continuously being mixed into the colloid, and as a result, the stannous tin ions, which stabilize the metallic palladium, are continually oxidized, and the tin oxide byproduct is precipitated. Therefore, by La Chatlier's Principle, the equilibrium disfavors stannous ions, which is unfavorable to the commercial process in turn. In the industry, until the present invention, this result has been generally ignored, and the solution to this problem was to simply continue to add more stannous chloride to the colloid to make up for the oxidative effects of the conveyor or discard the solution. However, this has proven to be quite expensive and wasteful, and the present invention deals with a more cost effective method of preserving the stannous ions from the harmful effects of the atmosphere.

Devices for on site nitrogen gas generation have long been utilized to obtain purified nitrogen or oxygen gas, and such an apparatus is disclosed in U.S. Pat. No. 4,011,065. In brief, “pressure swing adsorption” (PSA) systems fractionate air into high purity nitrogen streams and oxygen streams. The system works by exploiting differential adsorption affinities of the two gases. For example, certain silicates and zeolites are effective for preferably adsorbing nitrogen from the air mixture so that, by conducting air through a zeolite-filled adsorber, the first issuing gas is effectively enriched oxygen as nitrogen is slowed by adsorption.

### SUMMARY OF THE INVENTION

In accordance with an embodiment of the present invention, it has been discovered that in a conveyorized process of electroless deposition of metal on a non-conductive substrate, which method comprises treating the substrate prior to electroless deposition with a catalyst composition containing a tin-palladium colloid, an improvement in the efficiency of the catalytic bath is obtained by sparging nitrogen gas, preferably produced by a PSA purified nitrogen gas generation system, into the colloidal solution preferably via a porous pipe. The effect is a greatly retarded oxidation of the colloid stabilizing stannous ions, which enables the colloid to operate for longer periods of time and with less replenishment of stannous chloride.

It is particularly preferred to “bubble” (sparge) the nitrogen into the colloidal solution instead of only allowing it to permeate the chamber to form a “nitrogen blanket” on top of the colloidal flood. It is believed that by allowing the solution to be continuously saturated with nitrogen, the nitrogen particles are able to effectively displace the deleterious oxygen dissolved in the liquid activator, by artificially pushing the equilibrium by La Chatlier's Principle. Additionally, the bubbled nitrogen then forms a protective blanket on top of the flooded liquid, effectively stopping more atmospheric oxygen from attacking the colloid.

This method makes full use of the selectively closed mechanism, most often two rollers, which encloses the module, allowing the protective nitrogen blanket to take its full effect. Additionally, this method can also be used with a spraying conveyor apparatus preferably with the whole chamber is filled with purified nitrogen such that the sprayed liquid particles do not come into contact with substantial amounts of oxygen. Thus, the present invention enables the vastly superior conveyorized process to be utilized, while minimizing the costly loss of stannous ions. The activator bath will last longer, and catalyze plate better over its life.

The catalyzed substrate can then optionally by treated with an accelerator, which removes stannous tin on the activated surface. This is beneficial because it is palladium alone that provides catalytic activity, and additional tin on the substrate can inhibit electroless plating. Finally, the fully catalyzed substrate can be treated in an electroless plating bath, where due to the conveyorized processing, which is utilized throughout the entire process, it receives a consistent and uniform metal coating.

Lastly, this process has the long known advantage over the use of a solution of palladium chloride that a much smaller concentration of palladium is needed in a colloidal activator. This is a significant advantage due to the great expense of precious metals such as palladium. The present invention is accordingly of significant importance in the electroless plating of through-holes in printed circuit boards, particularly through-holes having high aspect ratios. The present invention allows the use of a conveyorized process, without the expensive consequence of using a solution of palladium chloride or of having to constantly replenish the stannous ions that stabilize the colloid.

As will be readily appreciated, the use of a relatively inexpensive PSA nitrogen generator to protect a liquid activator solution, such as the tin-palladium catalytical colloid, is a significantly novel approach that refuses to accept the substantial and wasteful loss of stannous chloride, as the industry has heretofore been forced to accept. The means for making such an apparatus, which allows for efficient dispersion of the nitrogen gas in the activator solution and throughout the conveyor module itself, is also provided.

### BRIEF DESCRIPTION OF THE DRAWINGS

FIG. 1 is a schematic perspective illustration of the activating module having rollers for a selectively closed mechanism and for providing conveyance for the substrate, a device for continuously flooding the module with the liquid activator, and in which a porous pipe is affixed to deliver nitrogen gas into the flooded solution.

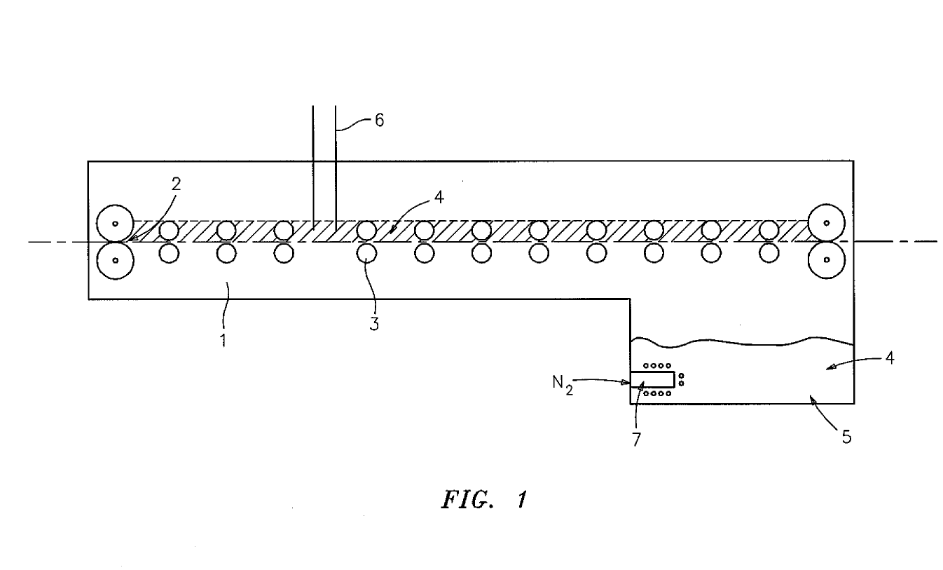

### DETAILED DESCRIPTION OF THE PREFERRED EMBODIMENT

The present invention is particularly applicable to the electroless plating of copper, including copper metal, copper alloys, or copper intermetallic, on any suitable non-conductive substrate composed of thermoplastic or thermosetting materials, glass, ceramics, and the like. The invention is particularly applicable, as previously noted, to electroless plating employed in the fabrication of printed circuit boards, where the substrates commonly encountered are based upon epoxy or polyimide, particularly glass reinforced versions thereof. The invention is primarily applicable to the activating and electroless plating of through-hole surfaces in double sided or multilayer printed circuit boards. The present invention combines the aforementioned technologies, in a novel way, which increases catalytic bath efficiency. It has not heretofore been known that obtaining a deoxygenated environment by introducing a favorable displacement equilibrium with another deoxygenated gas could have such a substantial and favorable effect.

In the preferred embodiment, the substrates to be electrolessly plated are first cleaned with suitable cleaners, known to the art, followed by appropriate rinses. Then, in the preferred embodiment of the invention, the substrates are placed into a dynamic flood conveyor, as described in U.S. Pat. No. 4,724,856, to be activated by a colloidal tin-palladium catalyst, which is also known as a liquid activation solution.

The substrate enters the module (the selectively closed enclosure) (1) through a selectively closed mechanism (2), where it is conveyed along the length of the enclosure, preferably by a series of rollers (3), and contacted with a tin-palladium catalyst (4), which is pumped to the module from reservoir (5) through at least one outlet (6). A suitable tin-palladium catalyst can be made by adding the following constituents in order and scaling the quantities up or down depending on the desired bath size:

### Formula 1:

### Palladium Chloride: 1 g

### Water: 600 ml

Concentrated Hydrochloric acid (38%): 300 ml

### Stannous Chloride: 50 g

The resulting colloid can be employed at room temperature, and the exposure time can range from 1-5 minutes by varying the velocity by which the substrate is conveyed. Additionally, the flooded tin-palladium catalyst is able to be contained within the module because the selectively closed mechanism prevents it from leaking out, especially during the introduction of the substrate.

Within the enclosure the tin-palladium catalyst is pumped up from a reservoir (5), and is dispensed throughout the enclosure by means of multiple outlets (6). Additionally, within the module itself, is contained, most preferably, a porous pipe (7), which is long enough such that it extends through tin-palladium catalyst in the reservoir below, and contains pores, most preferably, only where the pipe will be in contact with the tin-palladium catalyst, (4). Other means may be utilized as well, including a spraying nozzle, a non-porous pipe, or any other device that is capable of dispersing a gas inside such a module. This device is then connected to a deoxygenated gas generator. This generator must be capable of generating a substantially deoxygenated gas, and could feasibly be used if it generates any mixture of the following gases: nitrogen, helium, argon, hydrogen, or carbon dioxide. A deoxygenated gas is a gas that contains oxygen at a concentration lower than that found in the atmosphere, preferably less than about 15%, by weight, more preferably less than 5% by weight and most preferably less than 1% by weight, the preferred embodiment, the gas that is used is nitrogen gas.

The nitrogen gas is preferably generated from ambient air by exploiting differences in the physical properties of the gases in the ambient atmosphere. The process, as previously described, employs pressure swing adsorption to fractionate air and purify nitrogen. Depending upon the precise running conditions, nitrogen of a purity range of 95%-99.5% by weight can be easily obtained. In the preferred embodiment, a PNEUMATECH PMNG® Series nitrogen generator is employed, which is capable of generating 675 cubic feet of nitrogen per hour at standard temperature and pressure. Preferably, this generator is connected to the porous pipe in the flood conveyor module via an airtight hose.

Whenever the flood conveyor is operating, and thereby mixing and pumping the tin-palladium catalyst, the nitrogen generator delivers nitrogen gas into the module. Due to the porous pipe, the gas is bubbled into the tin-palladium catalyst (4) in the reservoir and then dispensed throughout the module. Preferably, the nitrogen gas is sparged into the tin-palladium catalyst (4) at a rate of about 0.0017 to 150 liters/minute (0.1-9,000 liters/hour). It is possible to utilize an airtight module in which the pressure of the nitrogen inside the enclosure is regulated. However, in the preferred embodiment, this is not necessary, and the nitrogen gas is allowed to escape, along with the displaced oxygen.

The substrate thus, most preferably, travels through the length of the selectively closed enclosure being contacted with the tin-palladium catalyst (the liquid activator) for a time of 30 seconds to 5 minutes, and wherein nitrogen gas is sparged into the catalyst at a rate of about 70 liters/minute. The substrate then exits this module through another selectively closed mechanism (11), and enters the next step of the process, which is preferably an accelerator solution that removes the stannous tin from the tin-palladium catalyst on the substrate surface. A preferable accelerator solution is described in U.S. Pat. No. 4,608,275, Example 1, and is fundamentally a pH adjusted solution containing sodium chlorite and sodium bicarbonate.

The substrate can now enter an electroless plating bath, which preferably plates copper onto the now activated and accelerated substrate. The electroless plating bath can consist of any known baths for the electroless deposition of copper, including formaldehyde-reduced baths, and hypophosphite-reduced baths. As known in the art, many hypophosphite-reduced baths are generally non-autocatalytic and, thus, cannot alone produce the plating thickness necessary for most printed circuit board applications (e.g., greater than 1.0 millimeters). Thus, in the preferred embodiment, formaldehyde-reduced electroless copper plating baths will be employed. Additionally, hypophosphite-reduced baths which have been modified, or are used in a manner, which renders them autocatalytic and hence capable of attaining the requisite plating thicknesses can be utilized. See, e.g., U.S. Pat. No. 4,265,943 to Goldstein, et al.; U.S. Pat. No. 4,459,184 to Kukanskis; and U.S. Pat. No. 4,671,968 to Slominski. Where non-autocatalytic hypophosphite baths are desired, though they are not preferred for this embodiment, a typical bath is disclosed in U.S. Pat. Nos. 4,209,331 and 4,279,948.

### Example 1

The dynamic flood module is arranged in the aforementioned manner, described as the preferred embodiment of the invention, and a tin-palladium catalyst is prepared at the specifications in formula 1. However, the flow of nitrogen gas is turned off, and the machine is run normally for a period of twenty four hours, with the catalyst being pumped into the flood chamber, dispersed, and drained back down into the reservoir at a rate of 200 l/min or 12000 l/hr. The objective of the experiment is to measure the decrease in stannous tin concentration due purely to oxidation by ambient oxygen. Therefore, no substrates are treated in this time period so that an accurate measurement may be made. Samples of the tin-palladium catalyst are taken upon start-up, and every four hours for a period of twenty four hours of total run time. These samples are then analyzed for their concentration of stannous tin. The analysis is performed by quantitative titration of the samples with standardized iodine and starch, a method widely known in the art. The results yield the following data:

TABLE I

| Running Time | Concentration of Stannous Tin |
|---|---|
| (hours) | (g/L) |
| 0 | 5.7 |
| 4 | 4.74 |
| 8 | 3.78 |
| 12 | 2.82 |
| 16 | 1.86 |
| 20 | 1.3 |
| 24 | 0.88 |

The concentration of stannous tin upon makeup is not 33 g/L as would be expected from the formula given, because some if the stannous tin is consumed in reducing the palladium ions to metallic palladium colloidal particles. However, the experiment shows that operating the tin-palladium catalyst in a conveyorized system without the present invention results in very substantial losses of stannous tin due to oxidation by atmospheric oxygen.

### Example 2

The same process is used as in example 1 is conducted except the nitrogen gas is now allowed to flow into the chamber, and is sparged into the tin-palladium catalyst, as described in the preferred embodiment of the invention. The rate that the nitrogen gas is sparged into the liquid activator is set to 450 liters per hour at standard temperature and pressure. The same analysis is performed as in example 1, and the data is given below:

TABLE II

| Running Time | Concentration of Stannous Tin |
|---|---|
| (hours) | (g/L) |
| 0 | 7.12 |
| 4 | 6.72 |
| 8 | 5.98 |
| 12 | 5.56 |
| 16 | 5.04 |
| 20 | 4.52 |
| 24 | 4.0 |

### Example 3

The same process is used as in example 1 is conducted except the nitrogen gas is now allowed to flow into the chamber, and is sparged into the tin-palladium catalyst, as described in the preferred embodiment of the invention. The rate that the nitrogen gas is sparged into the liquid activator is set to 900 liters per hour at standard temperature and pressure. The same analysis is performed as in example 1, and the data is given below:

TABLE III

| Running Time | Concentration of Stannous Tin |
|---|---|
| (hours) | (g/L) |
| 0 | 6.17 |
| 4 | 5.77 |
| 8 | 5.37 |
| 12 | 4.97 |
| 16 | 4.57 |
| 20 | 4.17 |
| 24 | 3.77 |

### Example 4

The same process is used as in example 1 is conducted except the nitrogen gas is now allowed to flow into the chamber, and is sparged into the tin-palladium catalyst, as described in the preferred embodiment of the invention. The rate that the nitrogen gas is sparged into the liquid activator is set to 1350 liters per hour at standard temperature and pressure. The same analysis is performed as in example 1, and the data is given below:

TABLE IV

| Running Time | Concentration of Stannous Tin |
|---|---|
| (hours) | (g/L) |
| 0 | 6.17 |
| 4 | 5.85 |
| 8 | 5.53 |
| 12 | 5.21 |
| 16 | 4.89 |
| 20 | 4.57 |
| 24 | 4.25 |

The foregoing analysis shows that the present invention indeed provides significant protection from oxidation for the stannous tin in the tin-palladium activator colloid. It has also been shown that sparging (bubbling) the nitrogen gas into the colloid slows the oxidation of the stannous tin even further. The result is a significantly more cost efficient bath that also meets the conveyorized standards of today's industry.

As will be apparent from the foregoing description, the process of the present invention, although described with particular regard to the activating of a surface for electroless copper plating, which is of primary interest in the fabrication of printed circuit boards containing through holes, also has applicability to the activation of surfaces for the plating of other metals, alloys or intermetallics, such as nickel, gold, and the like. So too, can the creation of a deoxygenated environment by the sparging of deoxygenated gas be utilized in other activation processes which employ a conveyorized system with a selectively closed enclosure, where the liquid, that is flooded into the chamber, has the propensity to react with atmospheric oxygen and produce an unwanted effect.

The foregoing description, then, is presented to describe and illustrate the invention and its preferred embodiments, and is not to be taken as limiting the invention whose scope is defined in the appended claims.

1. A method for activating a surface to receive electroless plating thereon comprising:
(a) transporting the surface through a selectively closed enclosure;
(b) providing a means to contain a liquid activator in the selectively closed enclosure and pumping the liquid activator such that the liquid activator contacts the surface when the surface is being transported through the selectively closed enclosure; and
(c) introducing a substantially deoxygenated gas into the selectively closed enclosure;
wherein the liquid activator solution comprises colloidal palladium particles and stannous ions and wherein the deoxygenated gas inhibits the oxidation the stannous ions in the liquid activator.

2. The method according to claim 1, wherein the substantially deoxygenated gas is selected from the group consisting of hydrogen, helium, argon, nitrogen, carbon dioxide, and mixtures of the foregoing.

3. The method according to claim 2 wherein said substantially deoxygenated gas comprises nitrogen gas.

4. The method according to claim 3 wherein the nitrogen gas is introduced at a rate of 0.1-9,000 liters/hour.

5. The method according to claim 3 wherein the nitrogen gas is introduced by means of bubbling or sparging the gas through the liquid activator.

6. The method according to claim 3, comprising the step of pumping nitrogen gas into the selectively closed enclosure by means of a porous pipe.

7. The method according to claim 3, comprising the step of spraying the nitrogen gas into the selectively closed enclosure by means of a spraying nozzle.

8. The method according to claim 3 wherein the nitrogen gas is obtained by purification of ambient air through pressure swing adsorption.

9. The method according to claim 3 wherein the nitrogen gas is of a purity range of at least 85% by weight.

10. The method according to claim 1, further comprising the step of pumping the liquid activator so as to flood the enclosure such that the activator contacts the surface when the surface is transported through the selectively closed enclosure.

11. The method according to claim 1, further comprising the step of pumping the liquid activator through a spraying nozzle such that the activator contacts the surface when the surface is being transported through the selectively closed enclosure.

12. The method according to claim 1 wherein the selectively closed enclosure comprises two rollers in contact with each other at the entrance and exit of the enclosure.

13. The method according to claim 1 further comprising treating the surface with an electroless plating bath after the surface leaves the enclosure.

14. The method according to claim 13 wherein said electroless plating baths is selected from the group consisting of copper electroless plating baths, nickel electroless plating baths, and tin electroless plating baths.

15. A conveyorized mechanism for activating a surface to be electrolessly plated, said mechanism comprising.
(a) a conveyor for transporting said surface;
(b) a selectively closed enclosure comprising;
(i) at least a portion of the conveyor;
(ii) a reservoir for containing a liquid activator;
(iii) a pump and piping capable of transporting the liquid activator from the reservoir to the conveyor area;
(iv) a selectively closed mechanism for allowing the surface to enter and exit the enclosure while substantially maintaining the liquid activator in the enclosure;
(v) a means for bubbling a deoxygenated gas into the liquid activator; and
(vi) walls establishing the extent of such enclosure and substantially containing components (i)-(v); and
(c) a source of deoxygenated gas.

16. A mechanism according to claim 15 wherein the deoxygenated gas comprises nitrogen.

17. A mechanism according to claim 15 wherein the selectively closed mechanism comprises pairs of pinch rollers.

18. A mechanism according to claim 15 wherein the source of deoxygenated gas generates nitrogen gas from atmospheric air using pressure swing adsorption.

19. A mechanism according to claim 15 wherein the means for bubbling deoxygenated gas comprises a porous pipe.

20. A mechanism according to claim 16 wherein the liquid activator comprises water, colloidal palladium particles and stannous ions.
